(19) United States
(12) Patent Application Publication
(10) Pub. No.: US 2007/0052314 A1
(43) Pub. Date: Mar. 8, 2007

(54) Structure of generator/motor

(76) Inventor: Ching-Yen Hsu, Shijr City (TW)

Correspondence Address: BIRCH STEWART KOLASCH & BIRCH, PO BOX 747, FALLS CHURCH, VA, 22040-0747, US

(21) Appl. No.: 11/219,851

(22) Filed: Sep. 7, 2005

(51) Int. Cl. H02K 21/12; H02K 3/00

(52) U.S. Cl. 310/179; 310/266; 310/268; 310/156.39

(57) ABSTRACT

This invention is directed to an apparatus of “structure of generator/motor”, primary consists of at least a pair of magnetic component and corresponding coil set, and characterized by: the magnetic poles with different magnetism connected with an appropriate type of permeable part to form a steady magnetic field; and fixed coil set among the pair magnetic component which is allocated by different pole magnetism opposite to each other; thereafter, attain the purpose of reducing the magnetic abrasion of conventional Carbon Brushes generator/motor and avoidance the inefficiency issues of generating/rotating.

### BACKGROUND OF THE INVENTION

I. Field of the Invention

The present invention is related to a device of a “structure of generator/motor”, especially refer to a magnetic component with permeable part used as magnetic field in the structure of generator/motor to decrease magnetic abrasion caused by disordered magnetic line of force when magnetic field and coil process relative movement or rotation.

II. Description of the Prior Art

A conventional motor is rotated by outside working, that is, transform electric power into mechanic power after power on; whereas generator takes advantage of the change of magnetic flux to produce sensitive electromotive, that is, transform mechanic power into electric power, while general conventional generator/motor is of rotation type, that is, all mechanic power output by rotation work, or generate electric by the work of rotation; the generator/motor in current market normally apply Faraday's law or Lenz's law as generating or driven principle.

Refer to FIG. 1 general generator/motor a consists of a shell body a1, and a stator a2 which is fixed around the inner edge of the shell body a1 and combined from a plurality of magnetic components a21, and a rotator a3 in the center of the shell body. Make uses of the magnetic field effect formed by the relative movement between the rolling rotator a3 and stator a2 to produce induction electric, and then output by the guide of the carbon brushes a4 situated above the rotator.

Because of the rotator a3 combined from several pieces of silica-steel a31 and coil set a32, the rotator a3 itself and stator a2 fixed at the inner wall of shell body a1 induce magnetic field effect, and result the rotator a3 stuck at the flow direction of the magnetic line of force, hence, rotator a3 has to resist the magnetic force before rotating, the power consuming to overcome the suction force cause extra energy expense, furthermore the conventional generator a transmit the electric by the contact between carbon brush a4 and rotator a3, the carbon brush a4 after long duration of usage become wear and tear more or less that cause electric voltage of generator a conflicts lower voltage, unsteady, and even short life duration, etc.

Refer to FIG. 2, the magnetic components of the conventional generator/motor makes use of two round plates with different magnetism (N and S magnetism) to yield the magnetic field. The two adjacent plates with different magnetism and arranged around the inner edge of the shell body of the generator/motor yield disorder allocation of magnetic line of force and cause the phenomenon of “magnetic abrasion”, and therefore impair the magnetic field of generator/motor, then bring the issues of inefficiency.

Accordingly, the present invention “structure of generator/motor” primarily makes use of the permeable part of magnetic components to produce the source magnetic field of the generator/motor, the permeable part could smooth the flow direction of magnetic line of force and make the evenly allocation of the magnetic line of force, whereas apply a coil set fixed on the shell body of generator/motor to reconcile with the movement of magnetic components, when magnetic components begin to progress relative movement or rotating, the steady flow direction of the magnetic line of force naturally yield a strong and steady magnetic field to gain the best generating or rotating efficiency, otherwise the coil set needs not to transmit electric via carbon brush, and set aside the worrisome of life duration.

### SUMMARY OF THE INVENTION

It is therefore a primary object of the present invention to provide an apparatus of magnetic component and coil set combination for generator/motor to form a strong and steady magnetic field to improve the inefficiency of conventional rotation type of generator/motor caused by the phenomenon of magnetic abrasion.

It is further object of the present invention of a “structure of generator/motor” primarily comprises a shell body, at least a pair of magnetic components and the corresponding coil set, especially refer to the magnetic component which is connected different magnetism poles with appropriate type of permeable part to produce a steady magnetic field, and then fixed the coil set opposite to the magnetic pole between the special allocating magnetic components, that is, different magnetism and opposite magnetic pole arranged to each adjacency. The coil set is combined from permeable or impermeable material wound with coil.

Accordingly, the permeable part of the magnetic component were used to guide the flow direction of magnetic line in the magnetic field to make the magnetic line of force allocate more evenly, and therefore improve the magnetic abrasion confronted by the conventional magnetic component. For example, if the magnetic field of present invention were used in motor application, input power into the coil to produce the magnetic field and induce relative movement (include shaking, sliding, and rotation etc.) by the function of the attractive and repulsive force. Hence the more steady and stronger the magnetic force produced by the magnetic component, the powerful the rotating torque yielded by the motor; otherwise, if the magnetic field of present invention were used in generator application, takes advantage of the relative movement of rolling the magnetic component (by water power, wind power, and man power etc.) to change electric currency on permeable part of magnetic components, and produce more steady and stronger electromotive for generating purpose.

### BRIEF DESCRIPTION OF THE DRAWINGS

FIG. 1 the assembly perspective view of conventional generator/motor

FIG. 2 the deployment view of conventional generator/motor

FIG. 3 the perspective view of the present invention

FIG. 4 the allocation view of the magnetic force of the present invention

FIG. 5 the activity view of the present invention

FIG. 6-12 the example application perspective views of the present invention

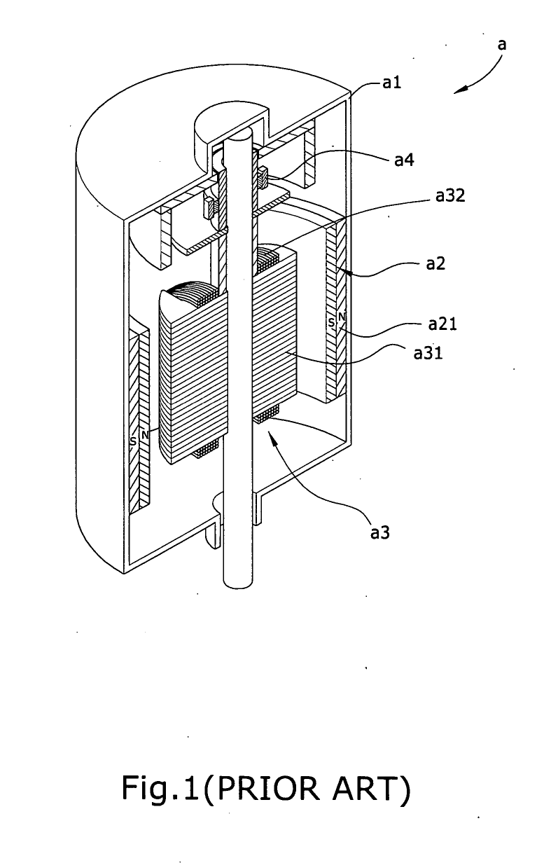

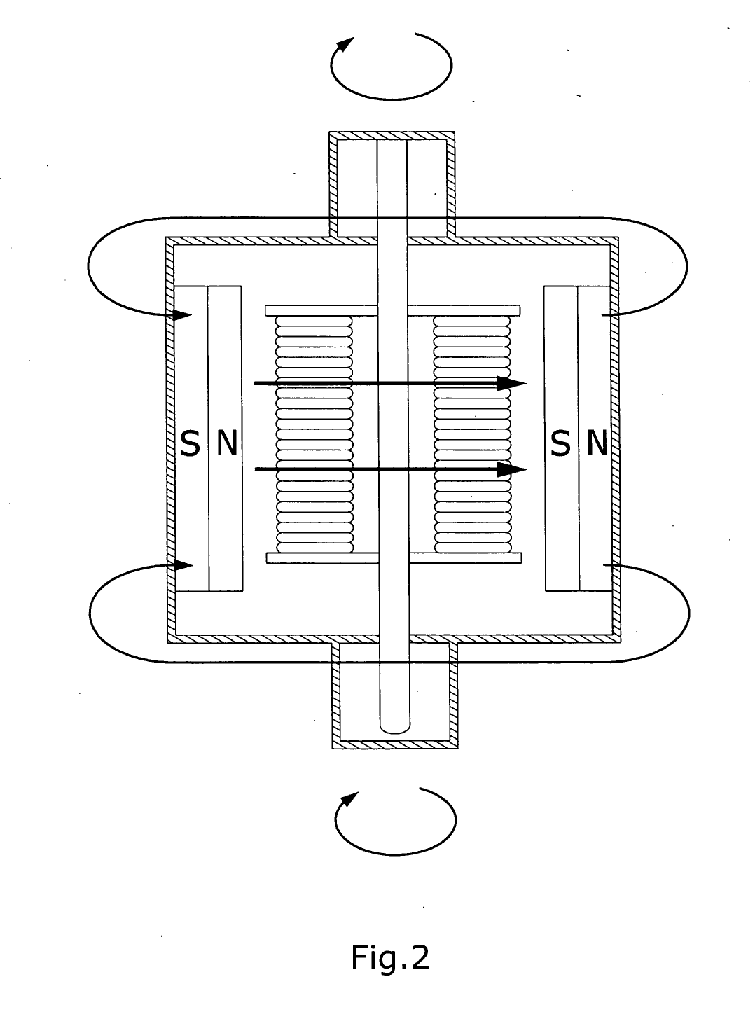

### DESCRIPTION OF THE PREFERRED EMBODIMENT

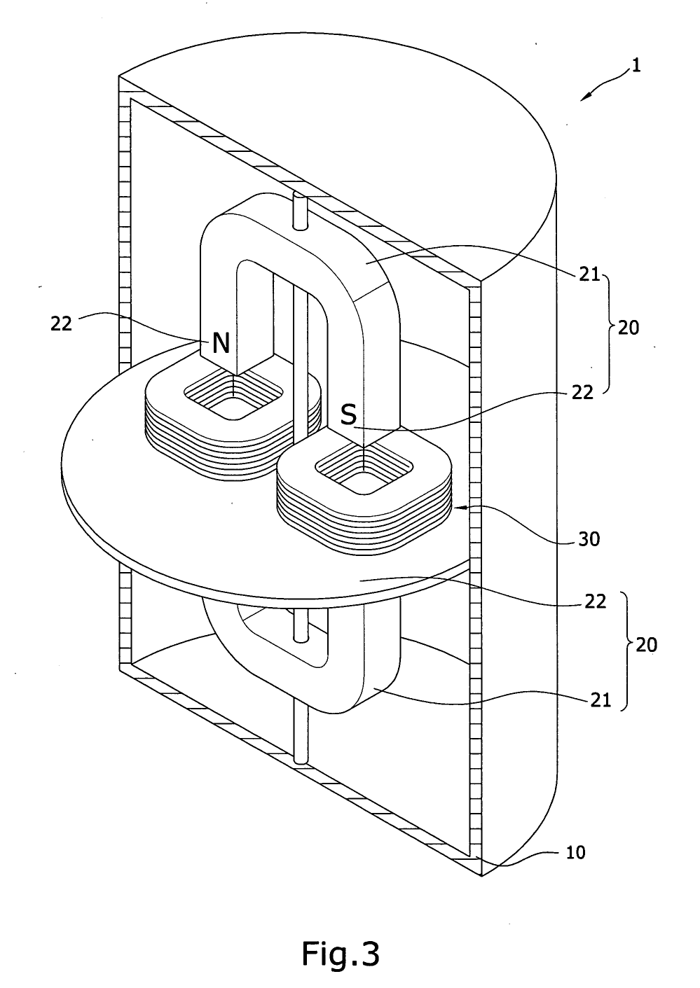

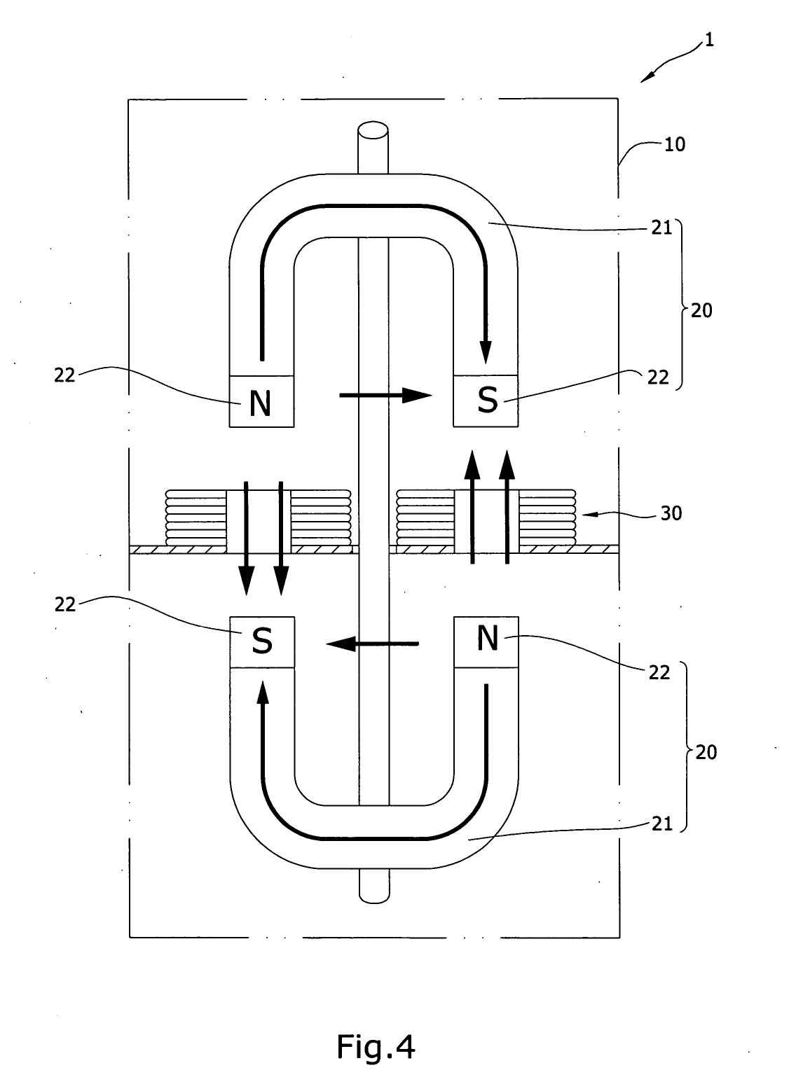

Referring to FIG.3 4, the structure of generator/motor in accordance with the present invention primarily includes a shell body 10 at least a pair of magnetic component 20 and corresponding coil 30.

Thereafter, fit a pair of magnetic component 20 at both end of a rotation axis, and make magnetic pole opposite to the other magnetic pole with adjacent different magnetism, and connect the different magnetic pole 22 at the same magnetic component 20 with appropriate permeable part 21, then fixed the corresponding magnetic pole numbers of coil 30 on the shell body 10 and right between the magnetic components 20; whereas the coil 30 comprises from winding coil on the permeable material or impermeable material.

The magnetic field as shown by the figure formed by the rotating axis of the magnetic component 20 will not have outflow magnetic line of force, therefore, once the rotating axis rolls, the magnetic flux changes in the inner side of the coil 30 to yield faradic and transmit from the output cord on the coil 30.

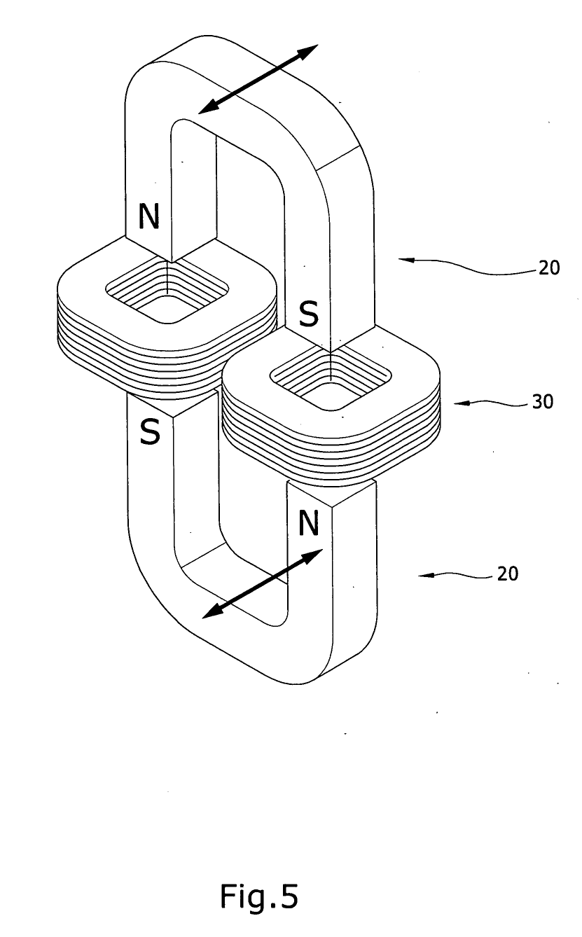

Refer to FIG. 5, the magnetic field can take advantage of the shaking by magnetic component 20 to transform the magnetic flux of inner coil 30 and yield faradic.

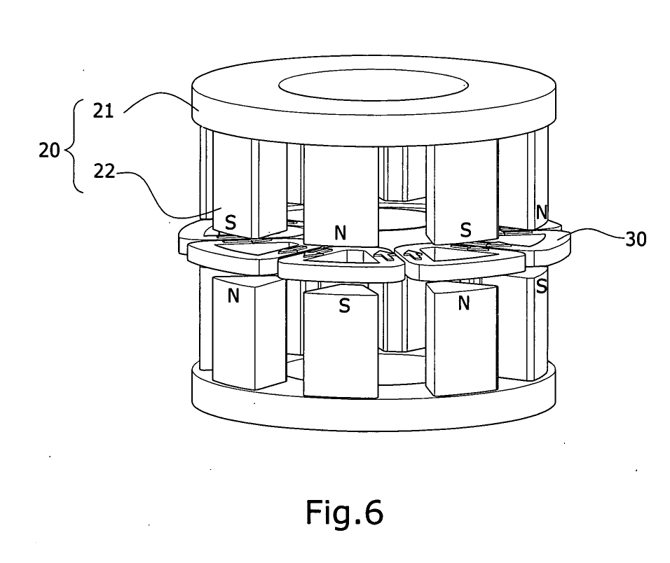

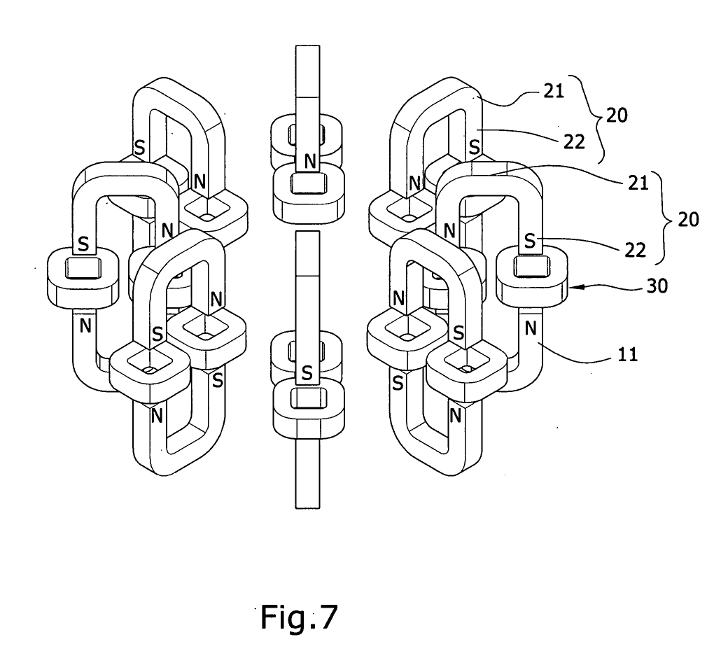

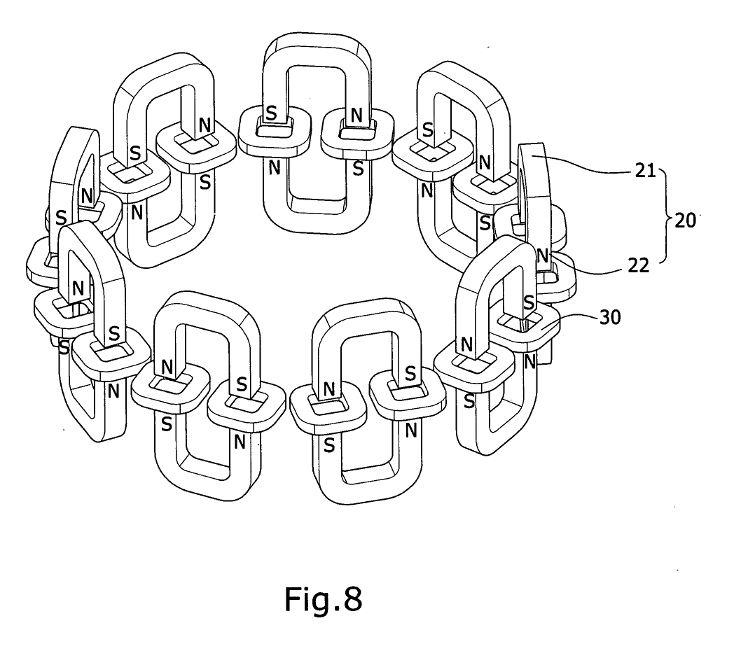

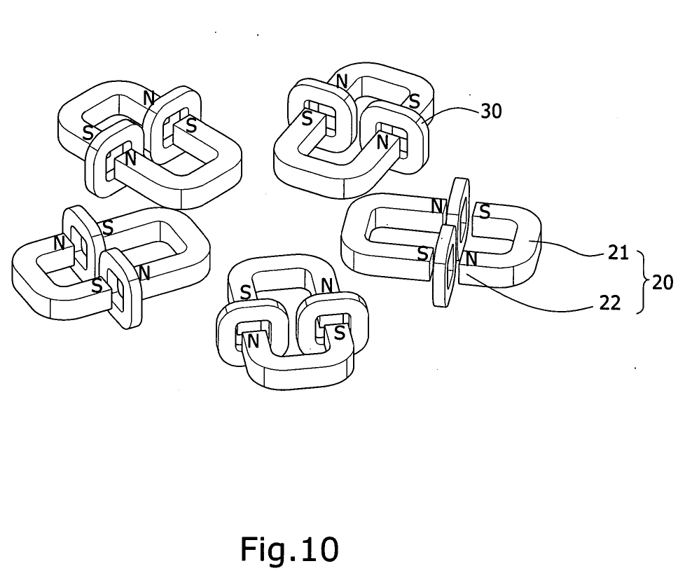

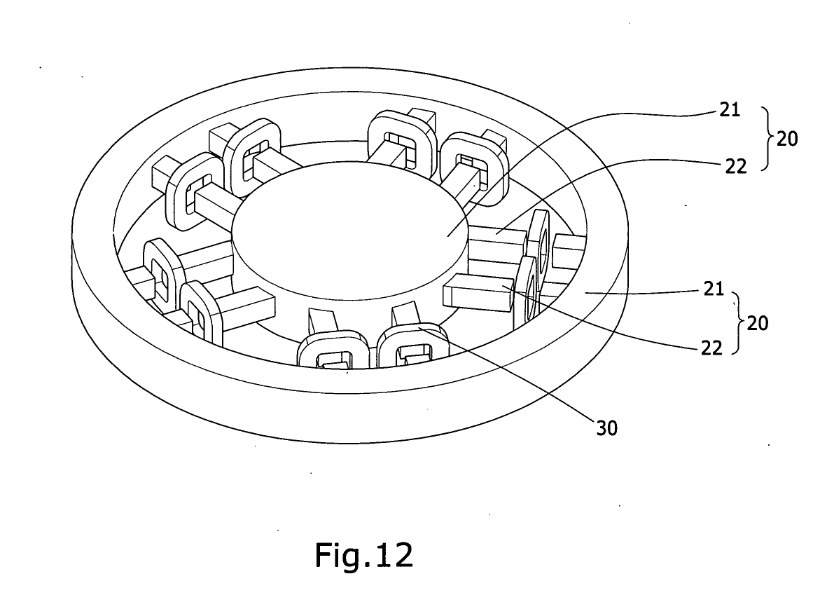

Refer to FIG. 6-12, shown the practical applications of the present invention: in FIG.6, 7, 8, circumvent appropriate sets of coil 30 with diameter plane parallel to the deployment plane, and arrange two permeable parts 21 of magnetic component 20 on both end of the same rolling axis; the magnetic poles 22 of magnetic component 20 corresponding to the coil 30 sets, the magnetic poles 22 of magnetic component 20 arranged in a position opposite to the other magnetic poles 22 of magnetic component 20 with different pole magnetism toward corresponding pole and the coil 30 sets fixed between the two magnetic components 20.

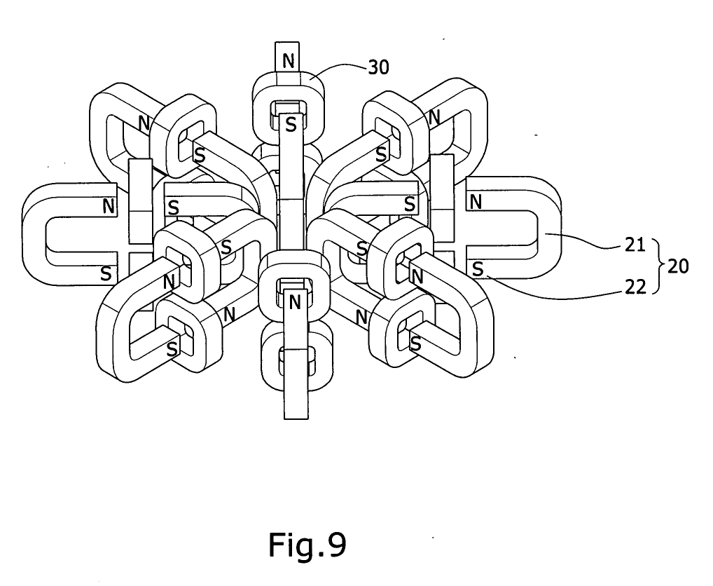

Refer to FIG.9 10, circumvent appropriate number of coils 30 on the same plane level with the coil's diameter surface perpendicular to the plane level; then deploy magnetic component 20 with permeable part 21 corresponding to each coil 30, and magnetic poles 22 spokes outward from circumventive center; and at the outside of the circumventive coils allocate along tangential circle edge magnetic component 20 with permeable part 21 opposite to each coil 30, and magnetic poles 22 spokes toward coils' circumventive center; makes magnetic pole 22 of the two magnetic component sets correspond to each other along with both sides of each coil.

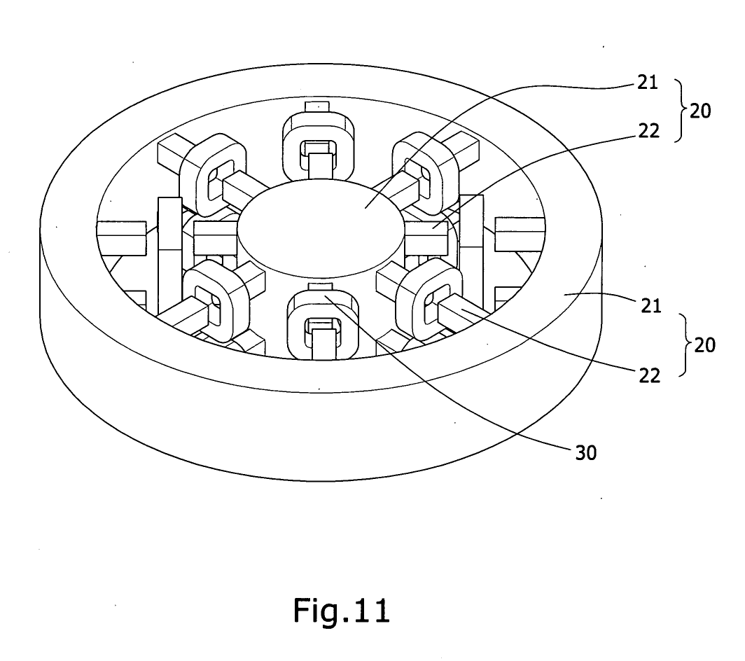

Refer to FIG.11 12, circumvent appropriate number of coils 30 on the same level with the coil diameter surface perpendicular to the level and arranged a permeable part 21 of magnetic component 20 at the circumvention center with magnetic poles 22 attached to the surface of center permeable part spokes outward to each corresponding coil 30, and circle the coils by an outer permeable part 21 of magnetic component 20 with magnetic poles 22 attached to inner surface of the outer permeable part spokes toward each opposite coil 30.

The allocation method of above-mentioned magnetic components 20 and coil 30 sets could yield a strong and steady magnetic field which can be changed by the relative movements (shaking, sliding, and rotation etc.) between magnetic components 20 and coil 30 sets depends on the option between the function of generator and motor.

Accordingly, the practical applications mentioned above are some of the best applied examples of the present invention. Alternation and modification in accordance with the present invention should involve into the patent range of the present invention.

In summary, the present invention is related to a “structure of generator/motor” taking advantage of permeable part to smooth the flow direction of the line of force of magnetic field produced by the magnetic components, and make the magnetic line of force disperse evenly, and therefore improve the magnetic abrasion of the magnetic field produced by the conventional magnetic component. Many changes and modifications in the above-described embodiments of the invention can, of course, be carried out without departing from the scope thereof. Accordingly, to promote the progress in science and the useful arts, the invention is disclosed and it's intended to be limited only by the scope of the appended claim.

What is claimed is:

1. A “structure of generator/motor” primarily comprising at least a pair of magnetic components and corresponding coil set, wherein the improvement is characterized by: the magnetic poles with different magnetism of magnetic components connected to an appropriate permeable part to yield a steady magnetic field, and then fixed corresponding number of coil set between two magnetic components with different magnetism pole toward each other.

2. A “structure of generator/motor” of claim 1, wherein coil set could made from permeable material wound by coil.

3. A “structure of generator/motor” of claim 1, wherein coil set could also made from impermeable material wound by coil.

4. A “structure of generator/motor” of claim 1, wherein circumvent appropriate sets of coil with coil diameter plane parallel to the deployment plane, and arrange two permeable parts of magnetic component on both end of the same rolling axis; the magnetic poles of magnetic component arranged in a position opposite to the other magnetic poles of magnetic component with different pole magnetism toward corresponding pole and the coil fixed between the magnetic components.

5. A “structure of generator/motor” of claim 1, wherein circumvent appropriate number of coil sets on the same plane with the coil's diameter surface perpendicular to the plane level; then deploy magnetic component with permeable part corresponding to each coil set, and magnetic poles spokes outward from circumventive center; and at the outside of the circumventive coil sets allocate along tangential circle edge magnetic component with permeable part opposite to each coil set, as well as magnetic poles spokes toward coils' circumventive center; therefore makes magnetic pole of the two magnetic component sets correspond to each other along with both side of each coil.

6. A “structure of generator/motor” of claim 1, wherein appropriate number of coil sets circumvent on the same plane with the coil diameter surface perpendicular to the deploy plane and arranged a permeable part of magnetic component at the circumvention center with magnetic poles attached to the surface of center permeable part spokes outward to each corresponding coil, and circle the coils by an outer permeable part of magnetic component with magnetic poles attached to inner surface of the outer permeable part spokes toward each opposite coil.
